(19) United States
(12) Patent Application Publication
(10) Pub. No.: US 2025/0112487 A1
(43) Pub. Date: Apr. 3, 2025

(54) POWER SUPPLY SYSTEM

(71) Applicant: TOYOTA JIDOSHA KABUSHIKI KAISHA, Aichi (JP)

(72) Inventor: Manabu SASAKI, Hashima-shi (JP)

(21) Appl. No.: 18/788,140

(22) Filed: Jul. 30, 2024

(30) Foreign Application Priority Data
Oct. 3, 2023 (JP) 2023-172314

(51) Int. Cl. H02J 7/00; B60L 50/60; B60L 58/20; H02J 7/34

(52) U.S. Cl. CPC H02J 7/007182; B60L 50/66; B60L 58/20; H02J 7/342; B60L 2210/10; H02J 2207/20

(57) ABSTRACT

A power supply system includes: a fixed type battery fixed to a drive system, which is driven by power; a detachable type battery group having a plurality of detachable batteries, which are connected in series to each other and which are connected in parallel with the fixed type battery and are detachable from the drive system; and a first switch that switches power from at least one of the fixed type battery and the detachable type battery group to drive the drive system.

### CROSS-REFERENCE TO RELATED APPLICATION(S)

The present application claims priority to and incorporates by reference the entire contents of Japanese Patent Application No. 2023-172314 filed in Japan on Oct. 3, 2023.

### BACKGROUND

The present disclosure relates to power supply systems.

Japanese Laid-open Patent publication No. 2016-025791 discloses a power storage system in which a plurality of battery packs each having a pack control unit for detecting a state of a battery, a battery capable of charging and discharging, a converter for changing a discharging current and a charging current of the battery, and a battery pack control unit for controlling the converter are connected in parallel to each other, and at least a part of the battery packs are detachable.

When the voltage is high battery and the voltage is low battery connected in parallel, but an excessive current flows as equalizing current, in the configuration of Patent Document 1, since the battery pack has a converter, to adjust the voltage difference between the batteries, it is possible to prevent an excessive

### SUMMARY

There is a need for providing a power supply system including a detachable battery which is detachable to the drive system, loss of power is small.

According to an embodiment, a power supply system includes: a fixed type battery fixed to a drive system, which is driven by power; a detachable type battery group having a plurality of detachable batteries, which are connected in series to each other and which are connected in parallel with the fixed type battery and are detachable from the drive system; and a first switch that switches power from at least one of the fixed type battery and the detachable type battery group to drive the drive system.

### BRIEF DESCRIPTION OF THE DRAWINGS

FIG. 1 is a schematic configuration diagram of a power supply system according to the embodiment.

### DETAILED DESCRIPTION

In the configuration of Japanese Laid-open Patent publication No. 2016-025791, by the converter with respect to the equalization current from the battery voltage is high functions as a resistor, because it prevents an excessive current flows, the loss of power is large. Furthermore, since the battery pack has a converter, weight is increased and portability is decreased, and the configuration is also complicated, leading to an increase in cost.

A power supply system according to an embodiment of the present disclosure will be described with reference to the drawings. In addition, components in the following embodiments include those which can be substituted and easily by those skilled in the art, or those which are substantially the same.

### EMBODIMENT

### Configuration of the Power Supply System

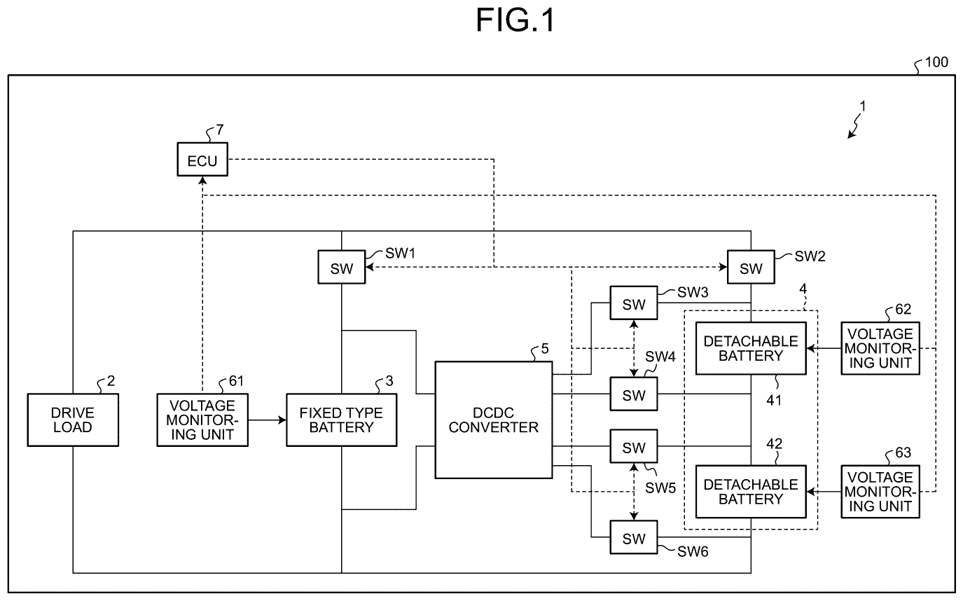

FIG. 1 is a schematic configuration diagram of a power supply system according to the embodiment. As illustrated in FIG. 1, in a vehicle 100 serving as a drive system, a power supply system 1 for supplying power to a drive load 2 includes a fixed type battery 3, a detachable type battery group 4, a DCDC converter 5, voltage monitoring units 61 to 63 serving as detection units, an Electronic Control Unit (ECU) 7 serving as a control unit, switches SW1, SW2 serving as a first switch, and switches SW3 to SW6 serving as a second switch.

The vehicle 100 may be, for example, a Battery Electric Vehicle (BEV) or a Plug-in Hybrid Electric Vehicle (PHEV), but may be a drive system that is powered by power supplied from the power supply system 1 and is not limited to a vehicle.

The drive load 2 is a motor mounted on the vehicle 100.

The fixed type battery 3 is fixed to the vehicle 100, but may be replaceable. The fixed type battery 3 is, for example, a battery pack of 12 battery cells are connected in series, the number of battery cells is not particularly limited. In the following, the voltage of each battery cell will be described as equal, it may be used battery cells voltage is different. When the voltage of each battery cell is equal, the voltage of the fixed type battery 3 is proportional to the number of battery cells. Further, regarding the fixed type battery 3, a single power of the fixed type battery 3 is capable of driving the drive load 2.

The detachable type battery group 4 is connected in parallel with the fixed type battery 3 has a detachable battery 41, 42 detachable to the two vehicles 100. The voltage of each detachable battery of the detachable type battery group 4 may be a value obtained by dividing the voltage of the fixed type battery 3 by an integer, the voltage of the detachable battery 41, 42 is substantially half of the voltage of the fixed type battery 3. In this case, the detachable battery 41, 42 is a battery pack, for example, six battery cells are connected in series. Further, the detachable type battery group 4, the single power of the detachable type battery group 4, and is capable of driving the drive load 2.

The DCDC converter 5 converts the voltage from the fixed type battery 3 and supplies power to the detachable battery 41 or the detachable battery 42.

The voltage monitoring unit 61 detects the voltage state of the fixed type battery 3. The voltage monitoring unit 62 detects the voltage state of the detachable battery 41. The voltage monitoring unit 63 detects the voltage state of the detachable battery 42. The voltage monitoring units 61-63, for example a voltmeter or an ammeter, may be configured to be capable of detecting the voltage state of the fixed type battery 3 and the detachable type battery group 4. The voltage monitoring units 61-63, although provided on the vehicle 100 side, the voltage monitoring unit 62 may be provided on the detachable battery 41 side, the voltage monitoring unit 63 may be provided on the detachable battery 42 side. By providing the voltage monitoring unit 62 and the voltage monitoring unit 63 to the vehicle 100 side, it is possible to increase the portability to reduce the weight of the detachable battery 41 and the detachable battery 42, simplify the configuration of the detachable battery 41 and the detachable battery 42, and it is possible to reduce the cost. In this case, the charger side for charging the detachable battery 41 and the detachable battery 42 includes a configuration for detecting a voltage state of the detachable battery 41 and the detachable battery 42.

The ECU 7 is composed of information processing equipment such as microcomputer which consists of a Central Processing Unit (CPU), a Field-Programmable Gate Array (FPGA), a Read Only Memory (ROM), and a Random Access Memory (RAM). The ECU 7 comprehensively controls the electric operation of each part of the vehicles 100. The ECU 7 is configured to perform an operation using the input data and pre-stored data and programs, and to output the operation result as a control command signal. In addition, the ECU 7 selects the detachable battery that supplies power from the fixed type battery 3 according to the detection result of the voltage monitoring units 61 to 63. Further, the ECU 7 supplies power to the detachable battery 41 or detachable battery 42 from the fixed type battery 3, the fixed type battery 3 and the detachable type battery group 4 and the equivalent voltage, the fixed type battery 3 and the detachable type battery group 4 connected in parallel to drive the vehicle 100.

The switches SW1, SW2 drives the vehicles 100 by switching to power from at least one of the fixed type battery 3 and the detachable type battery group 4.

The switches SW3 to SW6 switch the detachable batteries that provide power from the DCDC converter 5. The switch SW3 to SW6 are provided on the vehicle 100 side, the switches SW3, SW4 may be provided on the removable battery 41 side, and the switches SW5, SW6 may be provided on the removable battery 42 side. By providing the switches SW3 to SW6 on the vehicle 100 side, the weight of the detachable battery 41 and the detachable battery 42 can be reduced and the portability is reduced, the configuration of the detachable battery 41 and the detachable battery 42 can be simplified and the cost thereof can be reduced.

According to the power supply system 1 described above, it includes a detachable battery 41 and the detachable battery 42 which are detachable to the vehicle 100, since it does not include a converter in the circuit for supplying power from the detachable type battery group 4 to the drive load 2, the power loss is small.

Further, according to the power supply system 1, since the detachable battery 41 and the detachable battery 42 do not include a converter, the weight of each detachable battery is reduced and portability is improved. Further, it is possible to reduce the cost and simplify the configuration.

Further, according to the power supply system 1, since the detachable type battery group 4 is divided into a detachable battery 41 and the detachable battery 42, the weight per detachable battery is reduced and portability is improved, and the operation of removal and carrying is facilitated. Therefore, it is also possible to utilize the detachable battery 41 and the detachable battery 42 during disaster or field activity as an auxiliary power source.

The voltage of each removable battery of the detachable type battery group 4 may be a value obtained by dividing the voltage of the fixed type battery 3 by an integer, for example, when the integer is 3, the detachable type battery group 4 has three detachable batteries. In this case, each removable battery is a battery pack in which four battery cells are connected in series. With such a configuration, it is possible to further increase the portability of the removable battery.

### Method of Driving the Vehicle by the Power Supply System

When driving the vehicle 100 with the power delivery system 1, the ECU 7 preferentially uses the power of the detachable type battery group 4 to drive the vehicle 100. Each detachable battery of the detachable type battery group 4 is replaceable to the charged detachable battery, by preferentially using the power of the detachable type battery group 4, it is possible to use the vehicle 100 continuously for a long time. Further, when the power of the detachable type battery group 4 is exhausted, to reduce the weight of the vehicle 100 by removing the detachable battery 41 and the detachable battery 42, by driving the vehicle 100 with power from the fixed type battery 3, it is also possible to improve the power cost. Further, by preferentially using the power of the detachable type battery group 4, although the life of the detachable battery 41 and the detachable battery 42 is shortened first, since the detachable battery is replaceable, it is possible to prolong the battery life of the vehicle 100.

Further, when the voltage between the detachable battery 41 and the detachable battery 42 is different, by the detachable battery of low capacity reaches the discharge stop voltage, the other detachable battery also becomes unusable. For this reason, the ECU 7 selects a low-capacity removable battery as a removable battery that supplies power from the fixed type battery 3 according to the detection result of the voltage monitoring units 61 to 63. Then, by charging the removable battery of low capacity by the power from the fixed type battery 3 to the same capacity as the removable battery of high capacity, it is possible to use the detachable type battery group 4 for a long time.

Further, when driving the vehicle 100 is driven by the detachable type battery group 4 in a state where the voltage between the detachable battery 41 and the detachable battery 42 is different, the fixed type battery 3 assists the output of the detachable battery of low capacity, the vehicle 100 can be driven by the detachable type battery group 4.

Further, the ECU 7 supplies power to the detachable battery 41 or detachable battery 42 from the fixed type battery 3, so that the voltage of the fixed type battery 3 is equivalent to the voltage of the detachable type battery group 4, and the fixed type battery 3 and the detachable type battery group 4 connected in parallel to drive the vehicle 100. First, by making the fixed type battery 3 and the detachable type battery group 4 t have an equal voltage, it is possible to prevent an excessive current from flowing as equalizing current. Then, by driving the vehicle 100 by connecting the fixed type battery 3 and the detachable type battery group 4 in parallel, to drive the vehicle 100 efficiently by suppressing heat generation, it is possible to use the vehicle 100 continuously for a long time.

### How to Charge the Power Supply System

When charging the fixed type battery 3 and detachable type battery group 4 from the vehicle 100, the ECU 7 preferentially charges the fixed type battery 3. Each detachable battery of the detachable type battery group 4, since it is replaceable to the charged detachable battery, by charging with priority fixed type battery 3, it is possible to use the vehicle 100 continuously for a long time. Further, by preferentially charging the fixed type battery 3, even in a state where the voltage between the detachable battery 41 and the detachable battery 42 is different, by supplying power from the fixed type battery 3 to the detachable battery of low capacity, it is possible to drive the vehicle 100 by the detachable type battery group 4 and it is possible to use the vehicle 100 continuously for a long time.

When charging the detachable type battery group 4 from the vehicles 100, the ECU 7 preferentially charges the detachable battery with low total voltage or low charge capacity. Thus, to reduce the voltage difference of the detachable battery, it is possible to drive the vehicle 100 for a long time by the detachable type battery group 4.

In the embodiment, the ECU 7 has been described to select the detachable battery that supplies power from the fixed type battery 3 according to the detection result of the voltage monitoring units 61 to 63, but the DCDC converter 5 may have a function of selecting the detachable battery that supplies power from the fixed type battery 3 according to the detection result of the voltage monitoring units 61 to 63. Similarly, some of the functions of the ECU 7 may have the DCDC converter 5.

In accordance with the present disclosure, a power supply system can be realized that includes one or more detachable batteries that are detachable from the drive system and have a low power loss.

Further effects and variations can be readily derived by one skilled in the art. Thus, the broader aspects of the invention are not limited to the particular details and representative embodiments described and represented above. Accordingly, various modifications are possible without departing from the spirit or scope of the overall inventive concept defined by the appended claims and their equivalents.

What is claimed is:

1. A power supply system comprising:
a fixed type battery fixed to a drive system, which is driven by power;
a detachable type battery group having a plurality of detachable batteries, which are connected in series to each other and which are connected in parallel with the fixed type battery and are detachable from the drive system; and
a first switch that switches power from at least one of the fixed type battery and the detachable type battery group to drive the drive system.

2. The power supply system according to claim 1, further comprising:
a DCDC converter which converts a voltage from the fixed type battery to supply power to any of the detachable batteries; and
a second switch that switches the detachable batteries to which the power from the DCDC converter is supplied

3. The power supply system according to claim 1, further comprising:
sensing units which respectively detect voltage statuses of the fixed type battery and the detachable batteries.

4. The power supply system according to claim 3, further comprising:
a control unit which selects one of the detachable batteries to which power from the fixed type battery is supplied based on a detection result from the sensing units.

5. The power supply system according to claim 4, wherein
the control unit is configured to:
supply power from the fixed type battery to the selected detachable battery,
set a voltage of the fixed type battery substantial equal to a voltage of the detachable type battery group,
connect the fixed type battery and the detachable type battery group in parallel to drive the drive system.
